(19) United States
(12) Patent Application Publication
(10) Pub. No.: US 2006/0230454 A1
(43) Pub. Date: Oct. 12, 2006

(54) Fast protection of a computer's base system from malicious software using system-wide skins with OS-level sandboxing

(76) Inventors: Phani Gopal V. Achanta, Austin, TX (US); Riaz Y. Hussain, Austin, TX (US); Scott Thomas Jones, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/101,613

(22) Filed: Apr. 7, 2005

(51) Int. Cl. G06F 12/14

(52) U.S. Cl. 726/24

(57) ABSTRACT

A method and system that enables anti-virus scanning protection of a computer system by placing all changes/updates/installations on a system-wide skin and performing the scan and clean operation on the skin before allowing the components to be merged with those of the base system. A system-wide skin is provided, which covers the entire base system of a computer. A complete scan and clean operation is first performed on the base system before a first skin is placed over the base system. Then any new applications, files, or data are installed on the skin, which overlays the entire base system, such that no updates are actually made to the base system while the system-wide skin is present. All subsequent scan and clean operations are conducted only on the system-wide skin, thus significantly reducing the time for completing such operations. Multiple skins may be provided and clean data merged from one skin to another.

### CROSS REFERENCE TO RELATED APPLICATIONS

The present invention is related to the subject matter of commonly assigned, co-pending patent application Ser. No. ______ (Atty. Docket No. AUS92004927US1), filed concurrently herewith. The content of the related application are incorporated herein by reference.

### BACKGROUND OF THE INVENTION

1. Technical Field

The present invention relates generally to computer systems and more specifically to protecting computer systems from malicious software. Still more particularly, the present invention relates to a method and system for efficiently protecting computer systems from malicious software via use of system-wide skins covering the entire base system.

2. Description of the Related Art

Many types of malicious software (e.g., virus, worms, spyware) exist in today's computing environment. These “malicious” or “hostile” software provide code designed or modified to intentionally corrupt or steal data or programs from the computer system or network on which it runs. Protecting from hostile code is a challenging problem, since there is no way to programmatically distinguish positive and negative program actions, other than knowing whether they are ultimately good for the user or not. For example, a program may delete a file because the user has explicitly asked it to, but a malicious program could also delete a file against the user's will. In other words, there is no proper technical definition of “malicious” or “hostile” code—these being defined according to the behavior expected from a computer by its legitimate user.

Although it is possible to authenticate authorized users with password, trusted users themselves may endanger the system and network's security by unknowingly running programs that contain malicious instructions such as “viruses,” “Trojan horses,” “malicious macros,” “malicious scripts,” “worms,” “spying programs” and “backdoors.” A computer virus is a program that replicates by attaching itself to other programs. A Trojan horse is a program that in a general way claims to do what the user expects it to do, but instead performs malicious actions such as data destruction, data dissemination and system corruption.

Macros and scripts are programs written in high-level languages, which can be interpreted and executed by applications such as word processors, in order to automate frequent tasks. Because many macro and script languages require very little or no user interaction, malicious macros and scripts are often used to introduce viruses or Trojan horses into the system without user's approval. A worm is a program that, like a virus, spreads itself. But unlike viruses, worms do not infect other host programs and instead send themselves to other users via networking means such as electronic mail. Spying programs are a subtype of Trojan horses, secretly installed on a victim computer in order to send out confidential data and passwords from that computer to the person who put them in. A backdoor is a secret functionality added to a program in order to allow its authors to crack or misuse it, or in a general way exploit the functionality for their own interest.

All of the above programs can compromise computer systems and a company's confidentiality by corrupting data, propagating from one file to another, or sending confidential data to unauthorized persons, in spite of the user's will.

To combat these attacks, various protection techniques (both hardware and software) have been put in place to protect the computer systems. For example, one hardware technique involves using the virtual memory support provided by most operating systems. This approach may involve mapping the entire database in a protected mode, and selectively un-protecting and re-protecting pages as they are updated. However, this mapping can be very expensive, for example, on standard UNIX systems.

Software techniques provide an alternative to the above hardware approach. Traditionally, the protection mechanisms focused solely on scanning the system for the presence of the malicious software. These scans were carried out after the malicious software had entered the base system and in some instances, after the corruption of the base system files had begun. Along that line of software protection, several different software have been developed to combat certain types of malicious software.

Virus signature scanners, for example, detect viruses by using a pre-defined list of “known viruses.” They scan each file for each virus signature listed in their known virus database. Each time a new virus is found anywhere in the world, it is added to that database. However, today more and more new viruses are created every day, and the known-viruses list needs to be constantly updated in order to be effective. Regularly updating an anti-virus list is a heavy task for both the single-user and the network administrator and it leaves an important security gap between updates.

Another detection method, commonly called Heuristic Scanning consists of scanning programs for suspicious instructions that are typical to malicious programs and specifically viruses, without needing to have an exact signature of each virus in order to detect it in files. However, malicious program writers can avoid or hide those typical instructions by writing their code differently and/or encrypting it and thus malicious code and viruses rapidly avoid detection by Heuristic Scanners.

U.S. Pat. No. 5,408,642, U.S. Pat. No. 5,349,655, and U.S. Pat. No. 5,613,002 all disclose methods for recovering a computer program infected with a virus. The disclosed methods include generating fingerprint of data prior to infection by a virus and storing the fingerprint. A second fingerprint of data is then generated and compared to the prior strings of data, to determine if the data has been corrupted by a virus and for restoring the data to its initial state. These techniques do not prevent viruses from infecting, nor do they protect against other types of malicious programs. Besides, the finger database is susceptible to corruption by virus attacks.

U.S. Pat. No. 6,073,239 discloses a method where file I/O activity is filtered. Whenever a program attempts to infect or inject code into another program file, it will be denied. The method, however, is only designed to work against executable-files viruses. The method does not address other types of viruses, such as macro-viruses, nor other types of malicious programs: worms, Trojan horses, backdoors or spying software, because these malicious programs do not inject code nor modify other programs, but directly trigger malicious actions such as data corruption.

Other security techniques consist of certifying programs that are authorized to run and blocking out all the other, unauthorized programs. Unfortunately, these techniques are not always adapted to open systems where users receive and exchange many files.

Finally, one common security system consists of establishing access control lists (i.e. ACL, DACL) that define restrictions and rights as to which users are allowed or not allowed to access certain resources, based on those users' rights. However, this security scheme was designed to address the issue of user trust, not the issue of code trust, and users who run malicious programs within their systems will unknowingly compromise the integrity of every resource and file they're allowed to access with no further protection. If a user runs hostile code, the code will be able to corrupt and steal any data within the system or network to which its user has access. Thus, even though the authorized user does not intend to actually harm the files, a program ran by the user may still harm these files. Also, additionally to these security problems, access control lists are statically defined for each file and resource.

Because of the problems encountered with each of the above software techniques, developers have recently designed a method for executing certain applications that are susceptible to corruption within an environment referred to as a sandbox.

“Sandboxing”, as the technique is known, enables an assembly language programmer to add code immediately before a write instruction (in the execution sequence of the application program) to ensure that the instruction is not affecting protected space. Sandboxing allows of suspicious programs by running them in a secure “sandbox” environment, in which the program being tested is unable to harm the OS and other software installed on the computer system.

Sandboxing allows software programs to be executed within a controlled environment in which the program is unable to access operations that could damage the computer system. Sandboxing generally refers to enforcing restrictions on a specific instruction or a sequence of instructions. Sandboxing provides a way of preventing direct physical corruption of data and applications on a computer system (or OS processes).

One sandboxing technique involves a computer system executing (i) a pre-defined prologue before all executions of a specific instruction (e.g., write instructions) and/or (ii) a pre-defined epilogue thereafter. To implement this sandboxing technique, an assembly language programmer adds code to an application program immediately before each write instruction to ensure that the instruction is not affecting “protected space.” With this technique, data enters a computer system, but the sandboxing code constrains the way in which the data can be used within the system environment. Should the data contain a Trojan Horse or virus (i.e., malicious software), the malicious software has access only to the constrained environment and the data does not corrupt software applications (or system functions) outside that constrained environment, i.e. beyond the sandbox boundary. With current sandboxing techniques, a system is able to return to known states because sandboxing allows the separation of the changes from the base application and a return to the known state (i.e., the state just prior to implementing the sandbox to execute the particular code).

With current sandboxing techniques, a system is able to return to known states, because sandboxing allows the separation of the changes from the base application and a return to the known state (i.e., the sate just prior to implementing the sandbox to execute the particular code). Also, sandboxing of operating system installation drives enables many types of applications, which are conventionally implemented through other means.

Current sandboxing techniques are limited to the application level, i.e., current sandboxing is limited to a particular application and applies to specific types of files or data (e.g., received email). Some file systems map individual drives on to each other in a nested configuration to achieve application-level sandboxing. Other technologies boot a system with an initial boot drive, and then switch to an alternate drive to perform sandboxing. While these implementations provide some level of post boot security, the sandboxing technique is still limited to a particular application and applies only to specific types of files or data.

few general-purpose sandboxes have been built or proposed. For example, a research software named Janus is described in a paper entitled “Janus: An approach for Confinement of Untrusted Applications”, David A Wagner, UC Berkeley Computer Science Division, report CSD-99-1056, August 1999. This software utilizes security features within an operating system to separate software executing within the sandbox from other software executing on a computer system in the form of a main workstation desktop.

Further, United States Patent Application No. 20040139334 provides a sandbox application for receiving potentially harmful data and defining a sandbox desktop, characterized in that it also includes program code for encrypting potentially harmful data to render the data harmless and code for decrypting encrypted data for processing by an application constrained by the sandbox application. Important messages are not delayed awaiting expert inspection, but are instead made available to a system user in a constrained quarantine environment provided by a sandbox desktop.

These techniques, while effective in reducing the success of these attacks, are often not completely successful for various reasons. While sandboxing provides some assurances with regards to a specific application, application level sandboxing may perform poorly on certain architectures. Further, developers of these malicious software programs continually find new and innovative ways to circumvent most commercially available protection techniques.

The problem of detecting and recovering from corruption of data/files in a database system still remains to be solved in a pragmatic manner without adding considerable overhead to the computer system. The concern over physical corruption is further motivated by the increasing number of systems in which application code has direct access to system buffers, including extensible systems, object databases, and memory-mapped or in-memory architectures.

The use of sandboxing does not, however, really solve the problem. This is because viruses may still spread freely within the constrained environment provided by the sandbox and users will inevitably need to move data across the sandbox boundary, to reflect business needs to exchange data.

Malicious programs, however, may not perform the offensive or expected actions immediately during the test period, either because they detected that they're being tested, or because they're designed to perform their offensive actions randomly or at certain dates, for example. Hence, although a program seems to behave correctly during the test period, it can harm the system once it has passed the test and has been allowed to run for real. Also, positive programs may not behave correctly or not function at all within a sandbox, as they may need to access files and resources within the system for normal reasons.

Another recent development in the computer arts is the use of application-level “skins” to customize the interface of a particular application to a user's design. Skins are layers of visual and auditory interfaces that a user is able to place over an existing application to customize the user interface of the application. For example, the Winamp application (found at Internet site “www.winamp.com”) and music jukebox applications (found at Internet site “www.musicmatch.com”) provide a “change skin” feature that enables the user to change the visually representation of the application by placing a skin of data above the existing application. This skin of data is local level data, which may be discarded. Use of the skin offers protection to the underlying application code since the changes occur only within the skin and no changes/corruption occurs to the specific application data within the underlying application code.

Use of both sandboxing and/or skins, however, occur on the application-level. Also, sandboxing techniques predominantly find their application in the area of test environments that discard new generated data after a test run. Neither sandboxing nor the use of skins have been applied to more generalized use such as providing protection beyond a single application and supporting a comprehensive system-wide skin overlay (versus an application-level skin) covering the base system and/or entire operating system space.

Even with sandboxing, protection of the base system requires the user run one of the above software utilities on the base system. Conventional systems typically implement antivirus scans, which are run at each boot up or when selected by the user. Antivirus scans take a lot of time to perform weekly scans since they have to scan the entire/whole file system. Current optimizations involve storing a checksum of directories/files to know if a file has been touched since the last scan. However, these methods have the drawback that the checksum files can be compromised with a virus that is intelligent enough to know the data directory of the virus software. Other type of current optimizations involve the user specifying a set of “safe” files not to be scanned which is inherently risky if the viral activity is clever enough to disguise itself.

The present invention thus recognizes that it would be desirable to reduce the amount of time required to perform virus scans and other functions to provide protection for a computer system from malicious software. The invention further recognizes the desirability of being able to provide a sandbox overlay (skin) of the entire base operating system rather than just an application-level so that no leakage in the protection of the base system occurs, as is possible when implementing sandboxing for select application(s). These and other benefits are provided by the invention described herein.

### SUMMARY OF THE INVENTION

Disclosed is a method and system that enables anti-virus scanning protection of a computer system by separating all changes/updates/installations from the base system and performing the scan protection on the separated components before allowing the components to be merged with those of the base system. A system-wide skin covers the entire base system of a computer to provide system-wide protection of the base operating system (BOS) space. The basic input output system (BIOS) of the computer system enables one or more skins to be placed over the entire base system in a manner that is transparent to the base operating system. Multiple layers of system-wide skins are so provided, with each skin possibly provided on a separate removable medium or as a partition on the same media. When the skin is on a removable media, the removable media enables portability of the skin across computer systems of similar base configuration.

A user performs a complete scan and clean operation on the base system before placing a first skin over the base system. Then any new applications, files, or data are installed on the skin, which overlays the entire base system. A skin utility (or the BIOS) stores all newly added executables/registry keys/secret files to the overlay drive. The skin utility also directs any writes/updates/installations generated on the computer system to the separate drive/storage medium of the skin, such that no updates are actually made to the base system while the system-wide skin is present. Accordingly, all data updates, application or software utility installations, downloads, as well as any moves of files and/or data take place within the skin layer, and no actual updates occur on the base system level while a system-wide skin is in place.

While in skinned mode, the BIOS always prevents write access to the base device by marking the device as a read only device, making it virtually impossible for any code (including privileged code) to change the base image. The skin utility provides a pass-through block utility that includes code that redirects all write/update/installation operations bound to the base system drive(s) to a separate drive/storage medium that serves/operates as an skin overlay device. The pass-through block utility creates a complete system-wide skin overlay. The BIOS sends read operations to the overlaid device contents for completion prior to being forwarded to the base system, if the data is not within the overlay device.

The base system and operating system are not aware that the skin is present, because the skin is transparent to the operating system. Only the specific pointers of the device drivers within the BIOS are changed in the background, and so from the perspective of the operating system, processing is still being completed at the base system level and the base system drives are still being accessed and updated during the processing. Files that are modified within the skin level become new/updated files within the skin level only (on the skin's storage medium). No modification occurs at the base operating system level (i.e., on the base system drive).

A period is established at which the antivirus software triggers the system scan. When there is a skin in place, the antivirus software conducts the system scan at the skin layer, eliminating the time spent scanning the base system components, which have been clean in the initial complete scan and clean operation. In one embodiment, the antivirus software performs a complete scan and clean operation (base system and skin contents) every N cycles, where N is larger than 1, while the software scans and cleans the skin each cycle. Following each successful scan, the antivirus software provides the user the option of syncing/merging the contents of the skin overlay with the base image.

Because of the transparency of the skin and the ability of each skin to provide a different operating environment and/or application, multiple layers of skins may be simultaneously added using a combination of different, removable media or different partitions on the system drive. With these multiple skins available, the pass through block utility is programmed to support/enable nested overlays of skins, which are utilized to create separation of OS data, application data, and user data. With nested skin-levels, multiple system-wide skins are simultaneously placed over the base system with the highest level skin (i.e., the last skin added on top of the base system) being the one at which the user is currently operating/interacting and all current updates are performed.

With these multiple levels of skin overlays, the scan operation may scan and clean all skins in place when the scan operation is initiated. Thus, the scan and clean operation may scan and clean multiple different layers of skin concurrently. If adjacent layers are cleaned, then the content of those layers may be merged into a first of the two layers (i.e., the first layer placed over the base system). The skin utility provides this merge feature as an option to the user, who may wish to have all updates on a single trustworthy skin. Once a merge is completed, the second layer may then be reused as the skin overlay for the next cycle. Ultimately, the clean content of the layer immediately above the base system is incorporated into the base system.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer system within which the various features of the invention may advantageously be implemented;

FIG. 2A is a multiple-level representation of OS programs, applications, files, and data of each level of a computer system designed with multiple skin layers covering a base system level according to one embodiment of the invention;

FIG. 2B illustrates the base system device driver pointing to one of the skin layers among the three levels provided by FIG. 2A according to one embodiment of the invention;

FIGS. 3A and 3B respectively illustrate an exemplary graphical user interface showing the operating system view of the list of viewable directories and a secondary directory view, invisible to the operating system, that provides the additional skin directories, according to one illustrative embodiment of the invention;

FIG. 4 is a flow chart of the process by which a system-wide skin is incorporated into an antivirus scanning process according to one embodiment of the invention;

FIG. 5 is a flow chart of the processing/operation of a computer system configured with system-wide skins according to one embodiment of the invention;

FIG. 6 is a flow chart of the process by which antivirus scan and clean of the skin is completed dynamically according to one embodiment of the invention; and

FIGS. 7A and 7B are flow charts of processing read and write operations when a system-wide skin is provided according to two embodiments of the invention.

### DETAILED DESCRIPTION OF AN ILLUSTRATIVE EMBODIMENT

The present invention provides a method and system that enables anti-virus scanning protection of a computer system by separating all changes/updates/installations from the base system and performing the scan protection on the separated components before allowing the components to be merged with those of the base system. A system-wide skin covers the entire base system of a computer to provide system-wide protection of the base operating system (BOS) space. The basic input output system (BIOS) of the computer system enables one or more skins to be placed over the entire base system in a manner that is transparent to the base operating system. Multiple layers of system-wide skins are so provided, with each skin possibly provided on a separate removable medium or as a partition on the same media. When the skin is on a removable media, the removable media enables portability of the skin across computer systems of similar base configuration.

A user performs a complete scan and clean operation on the base system before placing a first skin over the base system. Then any new applications, files, or data are installed on the skin, which overlays the entire base system. A skin utility (or the BIOS) stores all newly added executables/registry keys/secret files to the overlay drive. The skin utility also directs any writes/updates/installations generated on the computer system to the separate drive/storage medium of the skin, such that no updates are actually made to the base system while the system-wide skin is present. Accordingly, all data updates, application or software utility installations, downloads, as well as any moves of files and/or data take place within the skin layer, and no actual updates occur on the base system level while a system-wide skin is in place.

While in skinned mode, the BIOS always prevents write access to the base device by marking the device as a read only device, making it virtually impossible for any code (including privileged code) to change the base image. The skin utility includes a pass-through block utility, which includes code that redirects all write/update/installation operations bound to the base system drive(s) to a separate drive/storage medium that serves/operates as an skin overlay device. The pass-through block utility creates a complete system-wide skin overlay. The BIOS forwards read operations to the overlaid device contents for completion prior to being forwarded to the base system, if the data is not within the overlay device.

The base system and operating system is not aware that the skin is present, because the skin is transparent to the operating system. Only the specific pointers of the device drivers within the BIOS are changed, and so from the perspective of the operating system, processing still occurs at the base system level and the base system drives are still being accessed and updated during the processing. Files that are modified within the skin layer become new/updated files within the skin layer only (on the skin's storage medium). No modification occurs at the base operating system level (i.e., on the base system drive).

A period is established at which the antivirus software triggers the system scan. When there is a skin in place, the antivirus software conducts the system scan at the skin layer, eliminating the time spent scanning the base system components, which have been clean in the initial complete scan and clean operation. In one embodiment, the antivirus software performs a complete scan and clean operation (base system and skin contents) every N cycles, where N is larger than 1, while the software scans and cleans the skin each cycle. Following each successful scan, the antivirus software provides the user the option of syncing/merging the contents of the skin overlay with the base image.

The invention involves providing a system-wide skin overlay for the current period of activity. In one illustrative embodiment, a new/clean skin overlay is provided each week. With the new overlay in place, the next virus scan only scans the contents of the skin overlay, such that with a scan cycle of every week, the scan and clean is performed on only a week of activity, rather than for the entire system (as conventionally done).

Viral activity is not able to detect the presence of the overlay and is unable to circumvent the overlay without driver level access. Since the choice of a skin-base combination is a boot time issue, any malicious ware would have to know the exact combination of ‘real’ drives present in the system while it is functioning in the skin mode. However, obtaining knowledge of the combination is not possible without a reboot, which, in the implemented embodiment, triggers an alert to the administrator that the skin has become defective. While in skinned mode, the BIOS always prevent write access to the base device by marking the device as a read only device, making it virtually impossible for any code (including privileged code) to change the base image.

The invention expands the capability of sandboxing and utilization of application skins from the application-specific implementations to a more comprehensive implementation in which a system-wide skin is provided and overlays the data/files/applications (etc.) of the base computer system. The invention capitalizes on the ability of the sandboxing technique to enable two layers of storage, a visible, read-only base system layer and a transparent, read-write system-wide skin layer. With this capability, the invention reduces/limits/substantially eliminates all secondary scans of the entire computer system for malicious software and replaces those complete system scans with a substantially faster scan of contents within the skin layer, (following an initial complete system scan).

Multiple layers of skins may be simultaneously added using a combination of different, removable media or different partitions on the system drive. With these multiple layers of skins available, the pass through block utility includes code to support/enable nested overlays of skins, which are utilized to create separation of OS data, application data, and user data. With nested overlays, multiple skins are simultaneously placed over the base system with the highest level skin being the one at which the user is currently operating/interacting.

With these multiple levels of skin overlays, the scan operation may scan and clean all skins in place when the scan operation is initiated. Thus, the scan and clean operation may scan and clean multiple different layers of skin concurrently. If adjacent layers are cleaned, then the content of those layers may be merged into a first of the two layers (i.e., the first layer placed over the base system). The skin utility (or antivirus software) provides this merge feature as an option to the user, who may wish to have all updates on a single trustworthy skin. Once a merge is completed, the second layer may then be reused as the skin overlay for the next cycle. Ultimately, the clean content of the layer immediately above the base system is incorporated into the base system.

While the features related to implementation of a system-wide skin is generally described below, a more comprehensive description of these features is provided in the related patent application, Ser. No. ______ (Attorney Docket No. AUS920040927US1), whose content has been incorporated herein by reference. The abbreviated description herein thus focuses on features of the system-wide skin overlay that are necessary to gain a better understanding of the use of the skin overlay to enable the functionality related to the present invention.

Computer System Hardware/Software Overview

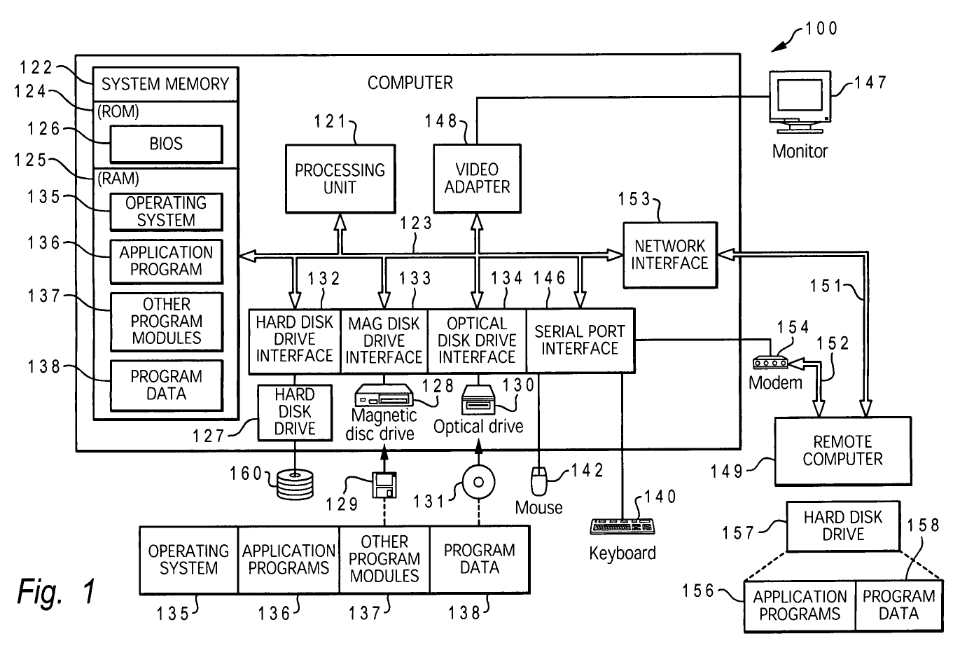

The invention is preferably implemented in a computer system, similar to computer system 100 illustrated by FIG. 1. The description of FIG. 1 is intended to provide a brief, general description of suitable computer hardware and a suitable computing environment within which the invention may be implemented. Although not required, the invention is described in the general context of computer-executable instructions, such as program modules, being executed by a computer, such as a personal computer. Generally, program modules include routines, programs, objects, components, and data structures that perform particular tasks or implement particular abstract data types.

As utilized herein, a utility may be a hardware utility or software utility or a combination of both hardware and software components. The term “skin” interchangeably refers to a software construct that covers the base system layer and the hardware medium (also referred to as an overlay device) on which the software construct exists and the skin-level functions are completed. These skin level functions include execution of an application, storage of all updates/data generated during execution of an application while the skin is in place and retrieval of data from the skin medium when the application provides a read operation.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules such as skin functionality, may be located in both local and remote memory storage devices.

With specific reference now to the figures, and in particular to FIG. 1, there is illustrated an exemplary computer system within which the functions of the invention may advantageously be implemented. Computer system 100 includes a processing unit 121, system memory 122, and system bus 123 that couples various system components including system memory 122 to processing unit 121. System bus 123 may be any of several types of bus structures including a memory bus or memory controller, a peripheral bus, and a local bus using any of a variety of bus architectures. System memory 122 includes read only memory (ROM) 124 and random access memory (RAM) 125. A basic input/output system (BIOS) 126, stored in ROM 124, contains the basic routines that help to transfer information between elements within the computer system 100 and recognize and configure device drivers for hardware devices, such as hard drives, during boot-up of the computer system 100.

Computer system 100 further includes hard disk drive 127 for reading from and writing to hard disk 160, magnetic disk drive 128 for reading from or writing to removable magnetic disk 129, and optical disk drive 130 for reading from or writing to a removable optical disk 131 such as a CD ROM, DVD, or other optical media. Hard disk drive 127, magnetic disk drive 128, and optical disk drive 130 are connected to system bus 123 by hard disk drive interface 132, magnetic disk drive interface 133, and optical disk drive interface 134, respectively. The drives and their associated computer-readable media provide nonvolatile storage of computer readable instructions, data structures, program modules and other data. In the exemplary embodiment, the combination of computer readable instructions, data structures, program modules and other data on a single removable medium provides a system-wide skin with the functionality described herein.

Although the exemplary environment described herein employs hard disk 160, removable magnetic disk 129, and removable optical disk 131, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of base system level program modules are stored on the hard disk 160, ROM 124 or RAM 125 of the computer system. Among these are base operating system (OS) 135, one or more application programs 136, other program modules 137, and program data 138. In addition to these base system level program modules, additional program modules may be provided on one or more of the memory devices (i.e., hard disk 160, magnetic disk 129, or optical disk 131). As illustrated, these program modules include operating system (OS) files 165, one or more application programs 166, other program modules 167, and program data 168. These latter program modules may provide the functionality of a system-wide skin covering the entire base system level.

For purposes of illustration, base OS 106 is described as a Windows-based operating system, such as Windows XP®, which is a trademark of Microsoft Corp. The functions of the invention are, however, applicable to any operating system that supports the implementation of system-wide skins and related functionality, as described herein. Thus, for example, the invention may also be implemented within a Linux-based OS. Other OSes which may implement the functionality of the invention available include Hewlett Packard's HP-UX®, IBM's AIX®, and Sun's Solaris®.

A user may enter commands and information into the computer system 100 through input devices such as keyboard 140 and graphical pointing device (mouse) 142. These input devices are often connected to CPU 121 through serial port interface 146 that is coupled to the system bus 123, but may be connected by other interfaces, such as a parallel port, game port or a universal serial bus (USB) or a network interface card. Monitor 147 or other type of display device is also connected to the system bus 123 via an interface, such as video adapter 148. In addition to monitor 147, computer system 100 may include other peripheral output devices, such as speakers and printers (not shown).

Computer system 100 may operate in a networked environment using logical connections to one or more remote computers, such as remote computer 149. Remote computer 149 may be another personal computer, a server, a router, a network PC, a peer device or other common network node. Depending on whether a wide area network (WAN) or local area network (LAN) (simply illustrated via connectors 152 and 151, respectively) is being accessed by computer system 100, the network access may be via modem 154 or network interface 153, respectively. It is appreciated that the network connections shown are exemplary and other means of and communications devices for establishing a communications link between the computers may be used. In a networked environment, program modules providing system-wide skin functionally may be stored in the remote memory storage device and the pointer(s) of the hard drive's device driver redirected to the remote storage device. Thus, as illustrated, remote computer 149 also includes operating system (OS) files 155, one or more application programs 156, other program modules 157, and program data 158.

Finally, while computer system 100 is illustrated with specific hardware and software components, the invention is applicable to any type of computer system configuration so long as the system-wide skin is supported by the system BIOS. However, it is understood that the above described embodiment is merely for illustration and not meant to imply any limitations on the actual structural design/configuration of the computer system in which the invention is practiced. Further, depending on implementation, it is understood that the functional features of the invention may be programmed into the system BIOS and or OS or provided as a utility for enabling system-wide skins.

Hard Disk Drive with Port and Firmware for Enabling (Removable) System-Wide Skin

Several different hardware configurations are presented for implementing the invention. In the first configuration, a single device driver is utilized to manage two or more devices, where the first device is the base system drive and the second (and other) device(s) is the drive supporting the system-wide skin. This first configuration enables portability of the system-wide skin. In another configuration, a single physical drive is provided, with a physical and/or logical partition separating the program modules of the base system from those of a internalized system-wide skin. The device driver points to the address of the skin's logical partition for all read/write operations performed while the skin is in place. For simplicity, such a skin is referred to as an internalized skin to distinguish it from an external skin provided by/on a separate, removable drive/medium from the base system drive. As illustrated below, both configurations may co-exist within a single computer system to provide multiple levels of skins.

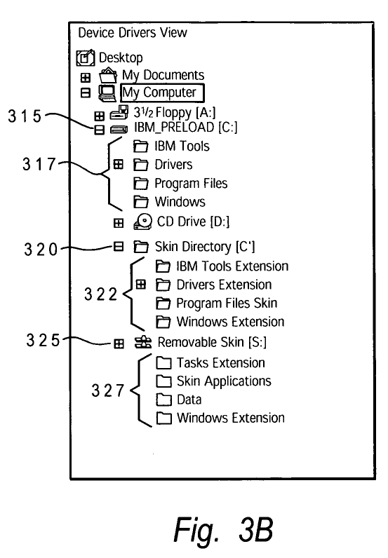

One hardware configuration that supports the implementation of an external, system-wide skin includes configuring/designing a hard disk drive interface/controller of the computer system with a skin connection port for connecting a removable medium on which the skin layer may be provided. Two different implementations of this new hard drive design are illustrated by FIGS. 4A and 4B. The first figure illustrates the hard drive itself designed with the capability of supporting a plug-in, removable drive, which may serve as a system wide skin utilized for any number of operations. The second figure illustrates the interface/controller providing the skin connection port. The portable medium connects directly to the hard drive or hard drive controller (interface) of the computer system. The portable medium may be physically removed and ported to another computer system with similarly configured hard disk drive and supporting firmware.

Base System Overlay with Multiple Skins

The other drive on which the skin exists may be a built-in secondary drive (e.g., D drive), a removable drive (e.g., S drive) or simply a logical/physical drive partition of the C drive (e.g., C′ drive). The specific character names of the particular drives are provided for example only, and not meant to place any limitations on the invention.

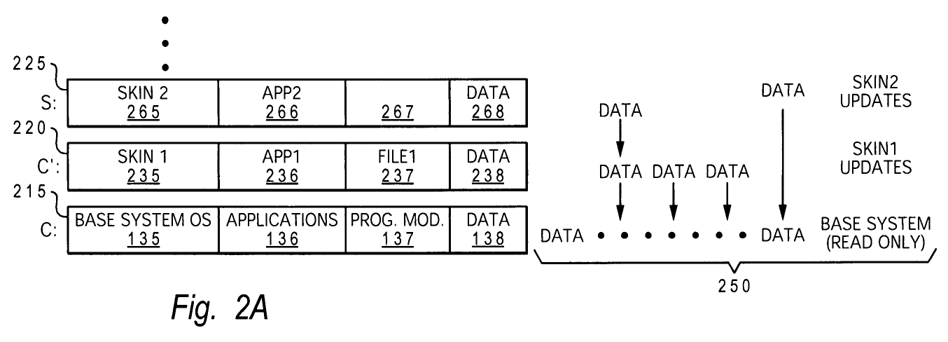

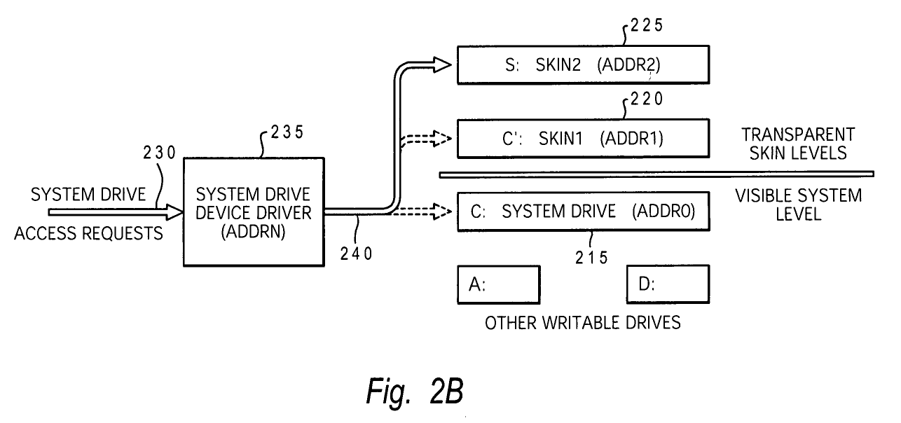

As illustrated by FIGS. 2A and 2B, described below, a combination of different, removable media or different partitions on the system drive provides multiple layers of skin that are concurrently added. With these multiple skins available, a pass through block utility is programmed to support/enable nested overlays of skins that create separation of OS data, application data, and user data. With nested overlays that include multiple skins placed over the base system, the user performs all reads/writes/updates at the highest level skin, typically the last skin installed.

FIG. 2A illustrates an exemplary layout of a system having multiple skins. As illustrated in FIG. 2A, base system exists on the C drive. In order to enable an internalized skin on the main system drive, the C drive is physically and/or logically partitioned such that a C′ drive is provided. C′ drive hosts the internalized skin1 and is illustrated as host skin drive 320. In addition to the host skin drive 320 (or C′ drive), the system includes a removable medium, S drive 325. This removable medium provides the external, removable skin2. Removable medium may be any one of a computer disk (CD), a thumb drive, a USB connected drive with storage media thereon.

Each drive is one of three separate levels. The first level represents base system (C drive) 215, which includes the program modules on the base system drive, such as base system OS 135, and application programs 136. Above base system level 202 is first skin level 220 (internalized skin on C′ drive), which also includes first skin OS files 235, application1 236, file1 237 and data 238. Finally, a second level provides an external/removable skin, skin level2 225 (on S drive), and includes second skin OS files 265, second skin application2 266, and data 268. Both first and second skin applications 236 and 266 execute to provide a particular them associated with the respective skin. Data 138, which exist at the base system 215 (i.e., on system drive C) is read-only data, while data 238 and data 268 are both read and write able. Application1 236 and application2 266 exist solely within their respective skin level, as do the respective files and data. As shown by the offset drawing 250 to FIG. 2A, the three levels of data 250 may reflect updates to system level data 138 at the specific skin level. According to the invention, however, the updates are retained within their specific skin level and the updates do not change the system level data 138.

(i) Transparency/Invisibility of Skin Layer(s)

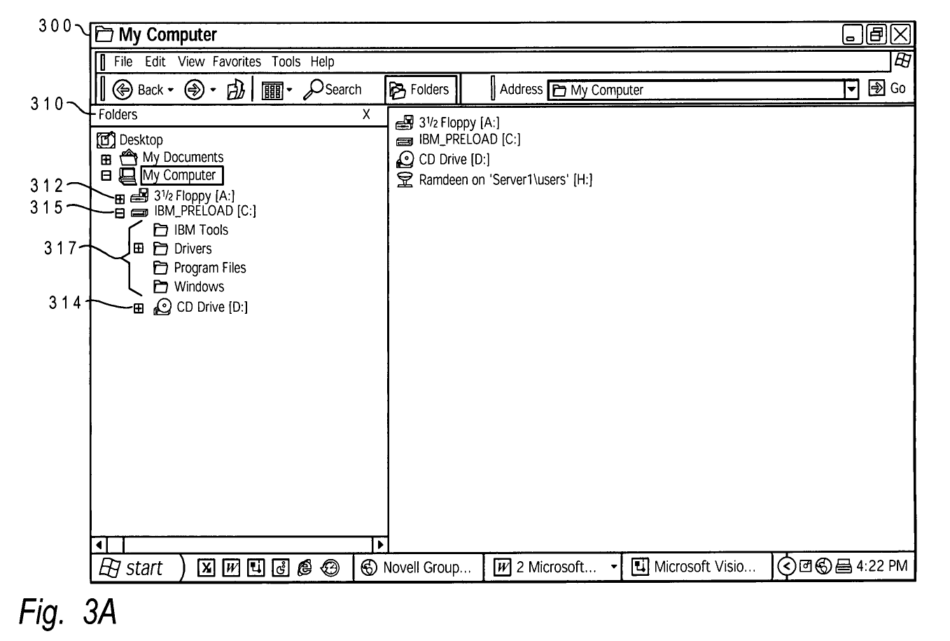

The base operating system is not aware that the skin is present because the skin is transparent to the operating system. Application of the skin masks the OS by redirecting the address pointers (i.e., the code within a device driver that identifies the specific physical device to which a read/write operation is to be directed) of the device drivers without alerting the OS of the change. Thus, with respect to FIG. 2A and as further illustrated with FIG. 2B and FIGS. 3A-3B, internalize skin1 212 and removable skin2 222 are transparent to the base operating system 135. The BIOS communicates with each storage device via a device driver. According to the invention, the pass through block utility reprograms the device driver of the system drive to intercept all application and system calls (for access to data) to the system drive and redirect the those calls to the respective storage device that provides the skin.

Only the specific pointers of the device drivers within the BIOS changes, and so from the perspective of the operating system, processing still occurs at the base system level and the processing still accesses and updates the base system drives. FIG. 2B illustrates this redirection of the device driver's pointer (i.e., address/directory at which the drive/storage medium is located). As shown therein, a system drive's device driver 235 has stored therein an address vector, which represents the address of the system drive (e.g., drive C) during regular operation of the computer system without any skin installed thereon. Device driver 235 has associated therewith address pointer 240 (which although illustrated as a physical pointer is actually a representation of the address component within the device driver). Illustrated to the right of device driver are multiple drives, including base system drive C 215 with associated address vector, first level, internalized skin drive 220 with associated skin1 address vector, and second level, external skin drive (S) 225 also with associated address vector.

The BIOS selectively redirects the pointer 240 to point to any one of the drives by changing the address vector within the device driver 235. When the device driver receives an access request 230 targeting the system drive 215, the device driver 235 forwards that access request to the specific drive to which the pointer 240 is presently pointing (i.e., the drive whose address vector is present within the device driver 235). In the provided illustration, the pointer 240 directs the access requests to the external skin drive 225.

Thus, although the access request 230 targets the system drive 215, no modification occurs at the base operating system level (i.e., on the base system drive 215). Rather, all accesses and thus all modifications occur at the highest level skin. Files/data that are modified within the skin level become new/updated files/data within the skin level only (on the skin's storage medium). It should be noted that the above physical representation of device drivers and other components is provided solely for illustration and to enable easier understanding of the features of the invention, which may be completed by firmware/software within the computer system.

As with the implementation that includes a single skin, current updates occur within the highest level skin, i.e., the last skin added on top of the base system. When a user adds a new skin to the system, the system reboots to allow the pass through block utility to change the pointers of the device driver to point to the new skin. This new skin may be installed over an already existing skin and becomes the highest level skin, which takes over all skin functions for the entire computer system.

That is, when accessing applications/data to perform read or write functions, the device driver of the system drive points to the device/drive of the highest level skin to obtain data rather than accessing the base system. Since each skin provides a system-wide overlay, Each skin level protects the base system level and each intermediate skin level from possible corruption from operations (changes/updates/installations) occurring in the skin level immediately above it. As described below, read operations occur at any level at which the data is available beginning with a search at the highest level skin and checking subsequent levels in sequence until the base system is checked (i.e., if data is not found in one of the skin levels).

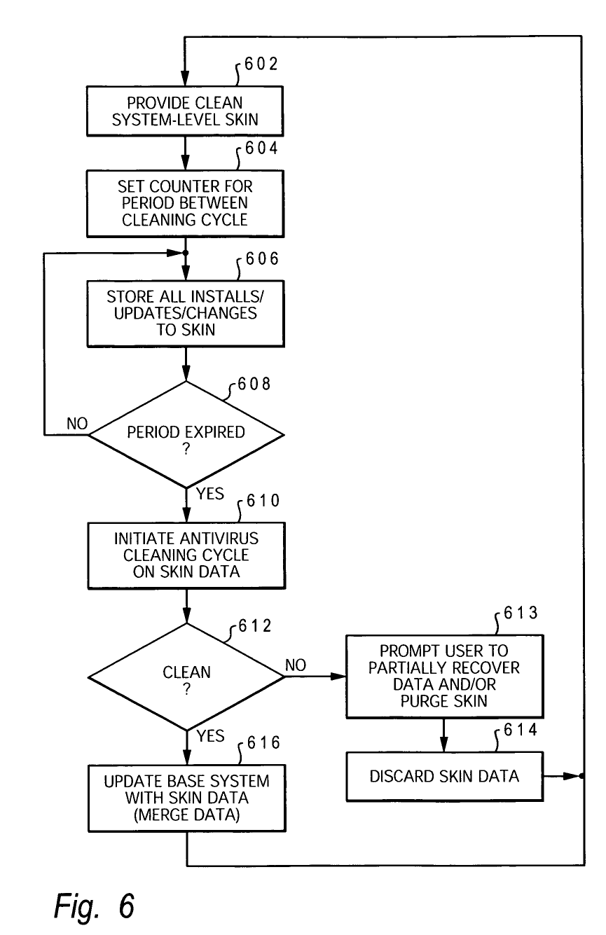

FIG. 7A illustrates the process of responding to a read operation, while a system-wide skin is present on the computer system. The pass through block utility detects/receives a read operation during the execution of the application at block 702. The pass through block utility directs the BIOS to first check on the skin medium for the requested data. Data retrieval mechanism of the computer system determines, at block 704, whether the data is found on the skin medium. When the data is found on the skin medium, the pass through block utility retrieves the data from the skin medium and forwards the data to the processor, as shown at block 706. However, when the data is not found within the skin level, the pass though block utility generates a search for the data within the base system drive (i.e., C drive), as shown at block 708.

FIG. 7B illustrates the processing of a write operation, while the skin overlay is present in the computer system. The application executing at the skin level generates a write operation at block 712. Once the pass through block utility detects the write operation, while a system-wide skin is present, the pass through block utility completes the write operation on the skin medium, as indicated by block 714. The pass through block utility enables the skin medium to emulate the base system drive, capture all write operations, and forward the write data to a skin drive.

A combination of FIG. 2B and FIG. 3A-3B illustrates in more detail the transparency of the skin levels from the perspective of the OS. FIG. 3A illustrates a graphical representation of visible drives of a computer system, which has been configured with both an internalized and an external, removable skin. Specifically, FIG. 3A provides an OS graphical user interface (GUI) 300 illustrating therein the presence of OS-visible physical drives along with directories associated therewith). OS-visible physical drives include system drive (C:) 215/315, floppy drive (A:) 312, and CD/DVD ROM drive (D:) 314. These drives are also represented in FIG. 2B below the line separating the visible system level from the transparent skin level. In contrast, FIG. 3B illustrates the view from the system BIOS, which includes both the above OS-visible physical drives as well as OS-transparent physical drives on which skins are provided. Separation of the OS-visible drives from the OS-transparent drives is provided by a solid line in FIGS. 2B and 3B. OS-transparent drives include internalized skin drive (C′:) 220/320 and external skin drive (S:) 225/325.

When a user opens the folders directory 310, the operating system provides only the OS-visible drives within the directory (FIG. 3A) because the operating system is unaware that the other OS-transparent drives are present as skin drives. Thus, the skin drive is also not visible to the user of the computer system. This feature is useful when a computer owner or system administrator wishes to provide access to the computer system to a secondary user but protect the integrity of the base computer system components from the user's actions. Notably, one embodiment allows a user to select whether to boot up the system with the skin drives visible within the system view and thus boot the base system in skinless mode. The selection may be via a prompt generated by the BIOS, when the BIOS detects the presence of the skin drive. The default configuration is to hide the skin from the system view, but this default maybe overridden by the user during system boot up.

In another embodiment, the user/administrator allows the skin drive overlay/receive all changes made to any of the drives on the base system. The pass through block utility sets up the skin drive as an artificial drive masking the original base system's drives, and the pass through block utility writes all updates to any of the other drives back to the skin drive.

Utility for System-Wide Skin Support

Regardless of the device or drive providing the skin (i.e., either via the above hard drive configurations, a single partitioned hard drive, and/or a separate removable storage medium (on optical drives, for example)), the system-wide pass through block utility supports the establishment of the system-wide skin on the computer system. The pass through block utility triggers the system BIOS to embed within the device driver for the system drive the address vector of the installed skin during boot up of the computer system.

In one embodiment, the pass through block utility presents the base storage device (hard disk) plus removable storage device as a composite device with a single system drive identifier (e.g., “C:”) from the perspective of the device driver and other system components. However, the BIOS changes the specific address of the logical partition or skin drive within the device driver and the pass through block utility then forwards all updates intended for the system drive to the removable skin medium 410 rather than update the hard drive itself. In another embodiment, the pass through block utility presents a separate drive identifier (e.g. “C′:” or “S:”) for the removable storage device than the system drive (C:). Each unique drive identifier shares the device driver of the system drive but has different address vectors and/or associated routing parameters for accessing the particular drive.

According to one embodiment, the base operating system includes the pass-through block utility, which comprises code that redirects all write/update/installation operations bound to the base system drive to a separate drive/storage medium that serves/operates as an overlay (skin) device. The pass-through block device creates a complete system-wide overlay (or skin) on which maybe installed applications, program modules, and data, of a particular theme. For consistency in presenting the invention, the pass through block utility is considered synonymous with a skin utility that supports all the functions required for enabling operation of the system-wide skin.

The period at which the overlay occurs may be during initial boot up of the system or following a subsequent partial boot, depending on implementation. If there is a skin storage media in place during boot up of the system by the BIOS, the BIOS boots the system with the skin as the active execution layer over the base operating system layer (i.e., the device pointers are set to access the skin level during updates). During boot up the BIOS loader hands control over to the pass through block utility to establish the skin drive access protocols (address vectors)

In one embodiment, additional code is provided within the BIOS to allow on-the-fly (post boot up) addition of a system-wide skin to the base operating system layer. This allows the system to perform a partial boot up to the skin layer to recognize the later addition of a system-wide skin. This also enables the BIOS to then begin to restrict any direct user access to the base system level and redirect all access to the installed skin.

In order to support the particular applications provided by the skin, certain system files of the base operating system may be overwritten by similar system files on the skin level. These skin-level system files may provide pseudo-operating system functions. The overwrite operation may occur automatically during set-up of the skin. Thus, when the BIOS detects the skin, the BIOS automatically changes the device pointers within the drivers of the base system devices to point to skin-level components (drive or application) rather than base system components (e.g., system drive). From a hardware-only standpoint, the BIOS modifies the pointers to point to the storage media that provides the skin (e.g., S drive) rather than the base system drive (e.g., C drive). The BIOS performs this redirection of drives by updating the device driver of the system drive to redirect certain requests (write operations, for example) to another drive.

Processing on Computer System with System-Wide Skin

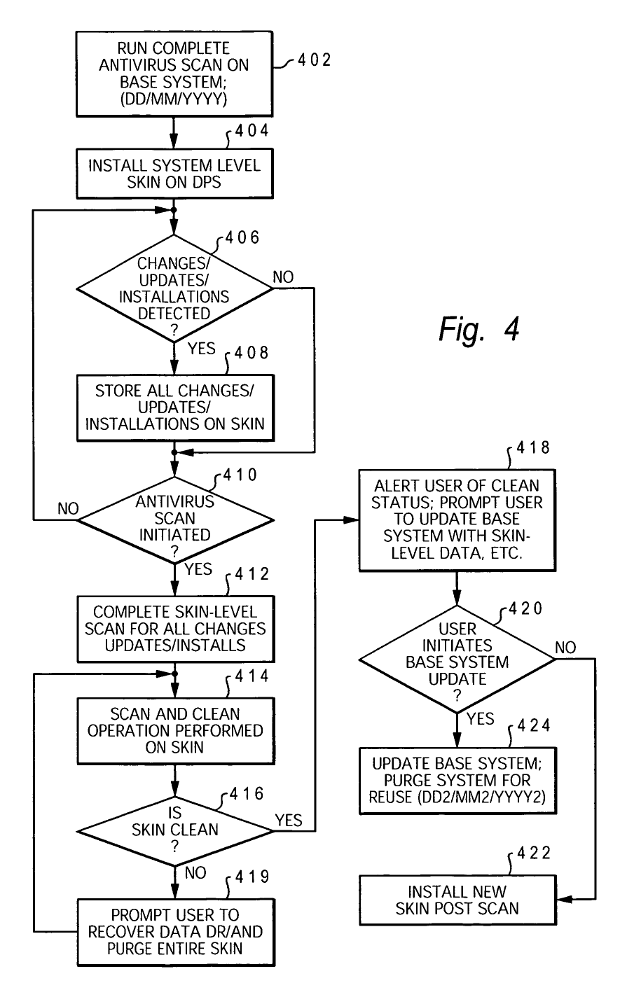

With reference now to FIG. 5, there is illustrated a flow chart of the process by which a system-wide skin is provided and utilized. The process begins at block 502 at which the system boots up and the BIOS initiates a search for an operating system and sets/initializes drivers for hardware devices. The pass through block utility checks, at block 504, whether there is a system-wide (operating environment) skin device present. If there is no system level skin present, the BIOS boots the system with the base system OS at block 506. Then the OS runs the applications found on the base system at block 508, and completes any changes/updates to data or application installation on the base system, as shown at block 509.

Returning to block 504, if there is a system-wide skin present, the system boots up at block 510 with device driver pointers changed to point to the skin device. If the skin is an operating environment skin, the OS of the base system merges with any OS extensions (or replacement files) found at the skin level to provide an operating environment supporting the skin applications. The processor executes the applications that are found on the skin level, as shown at block 512. At block 514, the system monitors whether there are any changes or updates to the data or installation of new applications made on the system. When such changes/updates/installations occur, the pass through block utility stores those changes/updates/installations on the skin device, as shown at block 516, and the pass through block utility does not write to the base system device.

The system monitors, at block 518, for the removal of the media on which the skin exists. Removal of the media results in removal of the system-wide skin (i.e., the skin medium removed from the computer system), and the system reboots at block 522. During the reboot, the device driver's address pointer is directed to the base system drive, and the BIOS provides control of the system to the base operating system.

Enhanced Malicious Ware Detection and Clean-Up Using System-Wide Skins

With the availability of the system-wide skin covering the base system, the invention is extended to provide substantially more efficient antivirus (malicious ware) scanning and cleaning technique. To simplify the description, the illustrative embodiment refers to “antivirus” scans which are understood to collectively describe any software designed to detect and/or clean malicious ware of any kind that may affect the system. With traditional antivirus scanning, the entire base system (all directories, folders and files) are scanned each time the antivirus scan is executed. Unlike with the conventional implementation of antivirus scan techniques, the invention enables a shorter, more efficient, skin-layer scan to provide the protection needed for the entire system. The use of a system-wide skin also makes the analysis of a spyware relatively simple since all changes made by the spyware are reflected in the skin drive. An administrator may then boot the system in a non-skin mode and analyzing the changes in the skin drive to get a relatively good idea of the changes made to the system files like Windows registry.

Referring now to FIG. 4, there is illustrated a flow chart of the process by which system-wide skins are utilized to enable more efficient (antivirus) protection of the computer system from malicious software. The process begins at block 402 at which the user runs a complete antivirus scan on the base system. The antivirus software records the data and time of the scan for use in scheduling future processes. Then, the user installs the system-wide skin over the base system at block 404. This process installs a clean skin over the entire base system, protecting the base system files from being contaminated by any new malicious software that is loaded on the computer system.

The skin utility checks for changes/updates/installations at block 406, and if any changes/updates/installations are detected, those changes/updates/installations are stored on the system-wide skin at block 408. Then, the skin utility checks, at block 410, whether the antivirus scan is initiated on the system. When an antivirus scan is initiated while the system-wide skin is covering the base system, the antivirus software completes only a skin layer scan, as indicated at block 412.

Following the skin layer scan, the skin utility checks, at block 414, whether the scan and clean operations are completed on the skin to remove any/all malicious software. Once all such malicious software has been removed, the skin utility provides the user a signal alerting the user that the skin layer changes/updates/installations are clean, as shown at block 416. Then, the skin utility prompts the user at block 418 to initiate a merge of relevant skin layer contents (changes/updates/installations) with the base system contents. The utility monitors at block 420 whether the user initiates the base system update, and when the update is initiated by the user, the base system is updated with the cleaned changes/updates/installations at block 424. The skin utility then either purges the skin of all data and prepares the skin for reuse for another cycle of changes/updates/installations, as shown at block 426, or the skin utility provides the user with control to partially merge important data from the skin before the skin is purged. Otherwise, a new skin may be installed over the current skin, which is not yet cleaned, as indicated at block 422.

The scan at the skin layer covers all the changes/updates/installations made within the skin layer since the last completed scan. The first skin layer scan is completed after the initial system wide scan and subsequent skin layer scans are completed after a previous skin layer scan. Thus, after each scan, the user may place a new/clean skin over the base system. New skins can be utilized since the skins are provided on a removable medium. In the illustrative implementation, the new skin is an empty skin that does not contain any skin specific application. That is, the skin does not provide operating system level functionality, as described above.

In one embodiment, multiple skins may be provided over the base system, with each skin holding a particular set of changes/updates/installations made after the skin is put in place. During the merge process, any skin determined to be clean by the antivirus software may be merged into another clean skin immediately beneath it. For example, assuming the user provides four layers of skin within the computer system, where the second and third layers are clean. When the antivirus scan is complete, the skin utility merges the content of the third skin layer into the second skin layer. The second skin layer takes the contents of both layers, and the third skin layer may then be reused for new updates following the antivirus scan. Notably, clean contents of a higher skin layer are not merged into a lower skin layer that is not deemed to be clean. This protects the clean contents from being contaminated, and allows the user to discard contents that are unclean without necessarily having to discard clean content from other skin layers.

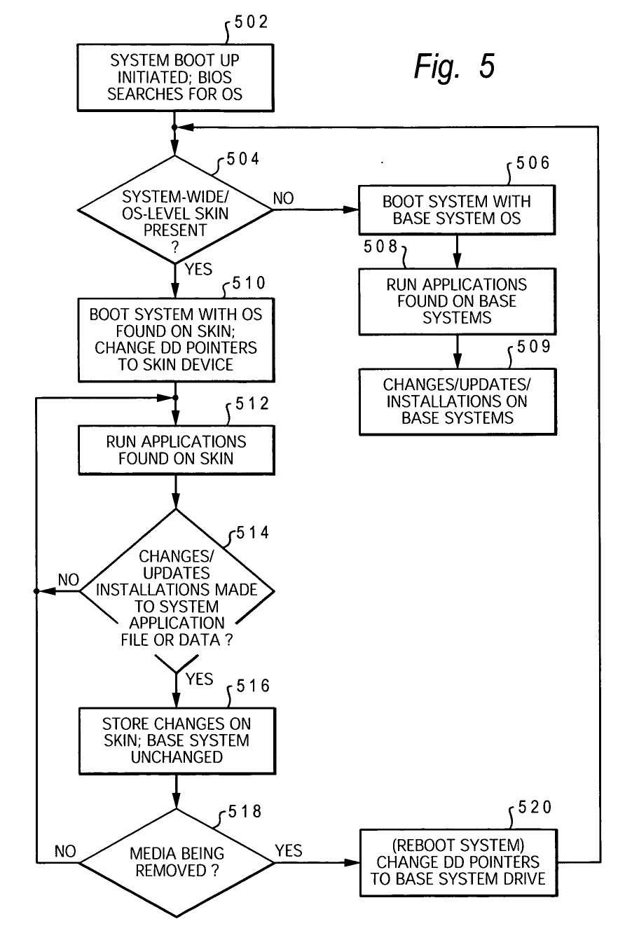

FIG. 6 provides a flow chart of a process by which the antivirus scans and merge functions are dynamically completely on a periodic basis. The process begins at block 602, which indicates that the user provides a clean system-wide skin over the base system. At the time the user provides a clean system-wide skin (following an initial system-wide antivirus scan), the antivirus software sets a counter/timer for the period between scheduled cleaning cycles, as shown at block 604. The skin utility stores all intermediary changes/updates/installations (i.e., the changes/updates/installations during the current period) within the skin, as stated at block 606. To make the schedule impervious to changes made to malicious programs, the schedule may be made a BIOS-level attribute, which can be accessed by the antivirus programs. Alternatively, the whole antivirus program itself may be run in the pre-boot stage.

The antivirus software determines at block 608 whether the period has expired, i.e., the counter reaches the threshold count value (e.g., 0 or N depending on implementation). If the period has expired, the antivirus cleaning cycle is initiated to clean the skin layer contents, as indicated at block 610. The skin utility (or antivirus software) checks at block 612 whether the skin is clean, and if not, then the skin data is discarded at block 614. The skin data may not be completely clean by running a virus scan, particularly since some virus may not be covered by the current version of the antivirus software. If the skin data is clean, however, the skin utility automatically merges the skin's content into the existing content on the base system, as shown at block 616.

The skin thus provides a directory of changes since the system was started following the last successful virus scan. The skin also makes the changes more visible and allows a user to quickly review those changes individually before the changes are accepted and merged into the base system. Also, in one embodiment, additional screening functions are provided by the skin. If an application attempts to change a system critical file, the skin utility (and/or OS) generates a warning that alerts the user/administrator that the software is attempting to access these files and alerts the user/administrator to monitor the software.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a data processing system having a base system with a base operating system (BOS) and associated system drive, a method comprising:
installing a system-wide skin over the base system, said system-wide skin covering the entire base system such that all changes/updates/installations are made within the system-wide skin;
performing a scan and clean operation for detecting and removing malicious ware on the data processing system by:
providing a first scan and clean operation of the entire base system prior to said installing of the system-wide skin; and
providing subsequent scan and clean operations on the system-wide skin, wherein only changes/updates/installs made since the latter of the installation of the system-wide skin and a previous skin-level scan and clean are targeted during a next scan and clean operation.

2. The method of claim 1, further comprising:
completing, within the system-wide skin, all changes/updates/installs occurring on the data processing system, wherein the base system is activated as a read-only level while said system-wide skin is in place and wherein further, said base system is made write-accessible only with pre-defined administrative authorization following a successful scan and clean operation of the system-wide skin, said completing including:
reading all requests for data from the system-wide skin whenever the data is available at the system-wide skin;
reading the request for data from the base system only when the data is not available at the system-wide skin, wherein when there are multiple skin layers, each read request that misses at the current skin layer is passed down to the next sequentially skin layer until the data is found at the next sequential skin layer or there are no more skin layers; and
writing all new data and updates to existing data to the system-wide skin.

3. The method of claim 1, wherein said system-wide skin is a first skin layer, said method further comprising:
enabling installation of multiple skin layers covering the base system, wherein each higher skin layer offers complete, system-wide skin protection for the skin layer below and the first skin layer offers complete, system-wide skin protection for the base system;
concurrently initiating a scan and clean of all skin layers;
determining whether the first skin layer and a sequential, second skin layer has been successfully cleaned; and
when both said second skin layer and said first skin layer have clean data, merging the data of the second skin layer into the first skin layer, wherein only a skin layer with clean data is allowed to merge data with another skin layer with clean data.

4. The method of claim 3, further comprising:
re-configuring the second skin layer whose data is merged into the first skin layer as a new skin for use in capturing changes/updates/installations made to the data processing system following the scan and clean operation.

5. The method of claim 1, further comprising:
completing the first scan and clean operation on all visible drives of the base system;
detecting a presence of the system-wide skin;
dynamically initiating a re-boot of the data processing system, responsive to the detecting of the system-wide skin;
when a BIOS discovers the system-wide skin during the re-boot:
dynamically updating a device driver of the system drive to point to a hidden drive associated with the system-wide skin rather than the visible base system drives, said update occurring during the re-boot such that the update is undetectable at the BOS level; and
providing support for overlaying the base system with the system-wide skin; and
when the subsequent scan and clean operation is initiated, directing the scan and clean operation to the drive to which the device driver points, wherein the scan and clean operation occurs on the hidden drive of the system-wide skin.

6. The method of claim 1, wherein said system-wide skin stores a first amount of content that is less than a second amount of content stored on the base system, such that the scan and clean operation on the system-wide skin is completed in less time than is required to scan and clean the base system.

7. The method of claim 1, further comprising:
monitoring for changes directed at system-critical files;
generating an alert to a user indicating a detection of such changes, said alert signaling the user that the software is attempting to access these files; and
temporarily storing said changes in the system-wide skin until proper authorization is received to update the system-critical files.

8. The method of claim 1, further comprising:
providing a directory of changes/updates/installations to the system since a last successful virus scan, said directory being stored within the skin layer;
enabling user review of the changes/updates/installations within the skin layer; and
allowing user manipulation of the changes/updates/installations, including one or more of: accepting the changes; merging the changes into the base system; and discarding the changes.

9. A computer program product comprising:
a computer readable medium; and
program code on said computer readable medium for:
installing a system-wide skin over the base system, said system-wide skin covering the entire base system such that all changes/updates/installations are made within the system-wide skin;
performing a scan and clean operation for detecting and removing malicious ware on the data processing system by:
providing a first scan and clean operation of the entire base system prior to said installing of the system-wide skin; and
providing subsequent scan and clean operations on the system-wide skin, wherein only changes/updates/installs made since the latter of the installation of the system-wide skin and a previous skin-level scan and clean are targeted during a next scan and clean operation;
wherein said system-wide skin stores a first amount of content that is less than a second amount of content stored on the base system, such that the scan and clean operation on the system-wide skin is completed in less time than is required to scan and clean the base system.

10. The computer program product of claim 9, further comprising program code for: completing, within the system-wide skin, all changes/updates/installs occurring on the data processing system, wherein the base system is activated as a read-only level while said system-wide skin is in place and wherein further, said base system is made write-accessible only with pre-defined administrative authorization following a successful scan and clean operation of the system-wide skin, wherein said code for performing all operations comprises code for:
reading all requests for data from the system-wide skin whenever the data is available at the system-wide skin;
reading the request for data from the base system only when the data is not available at the system-wide skin, wherein when there are multiple skin layers, each read request that misses at the current skin layer is passed down to the next sequentially skin layer until the data is found at the next sequential skin layer or there are no more skin layers; and
writing all new data and updates to existing data to the system-wide skin.

11. The computer program product of claim 9, wherein said system-wide skin is a first skin layer, said computer program product further comprising program code for:
enabling installation of multiple skin layers covering the base system, wherein each higher skin layer offers complete, system-wide skin protection for the skin layer below and the first skin layer offers complete, system-wide skin protection for the base system;
concurrently initiating a scan and clean of all skin layers;
determining whether the first skin layer and a sequential, second skin layer have been successfully cleaned; and
when both said second skin layer and said first skin layer have clean data:
merging the data of the second skin layer into the first skin layer, wherein only a skin layer with clean data is allowed to merge data with another skin layer below it; and
re-configuring the second skin layer whose data is merged into the first skin layer as a new skin for use in capturing changes/updates/installations made to the data processing system following the scan and clean operation.

12. The computer program product of claim 9, further comprising program code for:
completing the first scan and clean operation on all visible drives of the base system;
detecting a presence of the system-wide skin;
dynamically initiating a re-boot of the data processing system when the system-wide skin is detected;
when a BIOS discovers the system-wide skin during the re-boot:
dynamically updating a device driver of the system drive to point to a hidden drive associated with the system-wide skin rather than the visible base system drives, said update occurring during the re-boot such that the update is undetectable at the BOS level; and
providing support for overlaying the base system with the system-wide skin; and
when the subsequent scan and clean operation is initiated, directing the scan and clean operation to the drive to which the device driver points, wherein the scan and clean operation occurs on the hidden drive of the system-wide skin.

13. The computer program product of claim 9, further comprising program code for:
monitoring for changes directed at system-critical files;
generating an alert to a user indicating a detection of such changes, said alert signaling the user that the software is attempting to access these files; and
temporarily storing said changes in the system-wide skin until proper authorization is received to update the system-critical files.

14. The computer program product of claim 9, further comprising program code for:
providing a directory of changes/updates/installations to the system since a last successful virus scan, said directory being stored within the skin layer;
enabling user review of the changes/updates/installations within the skin layer; and
allowing user manipulation of the changes/updates/installations, including one or more of: accepting the changes; merging the changes into the base system; and discarding the changes.

15. A data processing system comprising:
a processor;
a base system having a base operating system stored on a system drive;
a system-wide skin device overlaying the system drive and providing a system-wide skin covering the entire base system such that all changes/updates/installations are made within the system-wide skin;
program logic for performing a scan and clean operation for detecting and removing malicious ware on the data processing system by:
providing a first scan and clean operation of the entire base system prior to activation of system-wide skin functionality; and
providing subsequent scan and clean operations on the system-wide skin, wherein only changes/updates/installs made since the latter of the activation of the system-wide skin and a previous skin-level scan and clean are subject to a next scan and clean operation;
wherein said system-wide skin stores a first amount of content that is less than a second amount of content stored on the base system, such that the scan and clean operation on the system-wide skin is completed in less time than is required to scan and clean the base system.

16. The data processing system of claim 15, further comprising program logic for:
completing, within the system-wide skin, all changes/updates/installs occurring on the data processing system, wherein the base system is activated as a read-only level while said system-wide skin is in place and wherein further, said base system is made write-accessible only with pre-defined administrative authorization following a successful scan and clean operation of the system-wide skin, said program logic including logic for:
reading all requests for data from the system-wide skin whenever the data is available at the system-wide skin;
reading the request for data from the base system only when the data is not available at the system-wide skin, wherein when there are multiple skin layers, each read request that misses at the current skin layer is passed down to the next sequentially skin layer until the data is found at the next sequential skin layer or there are no more skin layers; and
writing all new data and updates to existing data to the system-wide skin.

17. The data processing system of claim 15, wherein said system-wide skin is a first skin layer, said data processing system further comprising logic for:
supporting installation of multiple skin layers covering the base system, wherein each higher skin layer offers complete, system-wide skin protection for the skin layer below and the first skin layer offers complete, system-wide skin protection for the base system.
concurrently initiating a scan and clean of all skin layers;
determining whether the first skin layer and a sequential, second skin layer have been successfully cleaned;
when both said second skin layer and said first skin layer have clean data:
merging the data of the second skin layer into the first skin layer, wherein only a skin layer with clean data is allowed to merge data with another skin layer with clean data; and
re-configuring the second skin layer whose data is merged into the first skin layer as a new skin for use in capturing all changes/updates/installations made to the data processing system following the scan and clean operation.

18. The data processing system of claim 15, further comprising logic for:
completing the first scan and clean operation on all visible drives of the base system;
detecting a presence of a new skin media hosting a system-wide skin;
dynamically initiating a re-boot of the data processing system when said new skin media is detected;
when a BIOS discovers a system-wide skin during the re-boot:
dynamically updating a device driver of the system drive to point to a hidden drive associated with the system-wide skin rather than the visible base system drives, said update occurring during the re-boot such that the update is undetectable at the BOS level; and
providing support for overlaying the base system with the system-wide skin; and
when the subsequent scan and clean operation is initiated, directing the scan and clean operation to the drive to which the device driver points, wherein the scan and clean operation occurs on the hidden drive of the system-wide skin.

19. The data processing system of claim 15, further comprising logic for:
monitoring for changes directed at system-critical files;
generating an alert to a user indicating a detection of such changes, said alert signaling the user that the software is attempting to access these files; and
temporarily storing said changes in the system-wide skin until proper authorization is received to update the system-critical files.

20. The data processing system of claim 15, further comprising logic for:
providing a directory of changes/updates/installations to the system since a last successful virus scan, said directory being stored within the skin layer;
enabling user review of the changes/updates/installations within the skin layer; and
allowing user manipulation of the changes/updates/installations, including one or more of: accepting the changes; merging the changes into the base system; and discarding the changes.
